(19) United States
(12) Patent Application Publication
(10) Pub. No.: US 2002/0082169 A1
(43) Pub. Date: Jun. 27, 2002

(54) Procedure for the adornment of objects byn sublimation

(76) Inventors: Angel Sanchez Castellano, Madrid (ES); Lamberto Peris Moscardo, Madrid (ES)

Correspondence Address: Bourque & Associates, P.A., Suite 303, 835 Hanover Street, Manchester, NH, 03104, US

(21) Appl. No.: 09/879,560

(22) Filed: Jun. 12, 2001

(30) Foreign Application Priority Data
Dec. 22, 2000 (ES) P 200003081

(51) Int. Cl. B41M 5/035

(52) U.S. Cl. 503/227

(57) ABSTRACT

A Procedure for the adornment, by sublimation, of objects manufactured in a variety of materials, that consists of incorporating the ornamental motive or design on a template made of plastic or paper. The design is provided with conventional paint, and is applied on a receiving element or object, whose reception zone would first be buffed or sanded. The temperature of the object in contact with the transfer template with the design is raised to approximately between 140° C to 300° C for a period between 5 and 60 seconds producing the sublimation. The transfer template may be made or plain or coated paper or plastic and the design may be provided on the transfer template either by means of offset printing with special inks for sublimation or by means of printing with a blotter again using special inks for sublimation, varying the temperature that is applied depending on the surface to be transferred to.

### FIELD OF THE INVENTION

This invention relates to the adornment of articles by transference of ornamental patterns or motives from a transfer template to an object by sublimation.

### BACKGROUND OF THE INVENTION

Sublimation is the name given to the physical phenomenon in which a solid passes directly into the vapor state, or to the operation of purifying solid substances by passing directly to the vapor state and its subsequent condensation from this vapor state to the solid state.

There presently exists different procedures for the transference of ornamental motives incorporated on previously prepared templates from which, and with the help of a heating plate, the ornamental motive is transferred to the surface of a sheet of paper or textile material.

However, there is no known procedure that uses the phenomenon of sublimation for the adornment of objects manufactured in a variety of materials.

### SUMMARY OF THE INVENTION

The present specification relates to a procedure for the adornment, by sublimation, of objects manufactured from a variety of materials, whose purpose lies in transferring the figures, patterns, graphics, etc., situated on a template or base, previously prepared and provided with the necessary ornamental motive. The transfer template may include a sheet of plastic, paper or any other material and the ornamental motive is to be transferred to a receiving base, which could be any other object and in different materials, including precious and semi-precious stones, furs, textiles, etc. Paint or ink is used for making the patterns on the template and by means of using the physical process of sublimation, the adornment is transferred in a simplified way.

Another object of the invention is the fact that the transmission of the pattern to the template or base, when this is made of paper, can be effected by means of offset printing with special inks made for sublimation, or by means of printing using a plotter with special inks made for sublimation of patterns on paper.

### BRIEF DESCRIPTION OF THE DRAWINGS

These and other features and advantages of the present invention will be better understood by reading the following detailed description, taken together with the drawings wherein:

FIG. 1 is a schematic plan view of a receiving object for receiving an ornamentation design, according to one aspect of the present invention;

FIG. 2 is a schematic plan view of a transfer template including an ornamentation design, according to one aspect of the present invention; and

FIG. 3 is a schematic plan view of a transfer template including an ornamentation design in place on the receiving object which will receive the ornamentation by process of sublimation, according to the present invention.

### DESCRIPTION OF THE INVENTION

The procedure for the adornment by sublimation of objects manufactured in a variety of materials that the invention proposes is a novel method within the area of its application. The present method is a significant enhancement in relation to the conventional procedures, reducing the costs and presenting a substantially improved finish than the already known methods, with the transferred ornamental motive tending to last longer. Also, on being configured as a heat procedure, it eliminates totally and completely the existence of toxic gases, and eliminates the dangerousness with similar methods in which it has been known to contract cystic fibrosis and other pulmonary diseases due to the presence of toxic gases.

More specifically, the procedure for the adornment by sublimation of objects manufactured in a variety of materials is based on the realization of three different parts. These are:

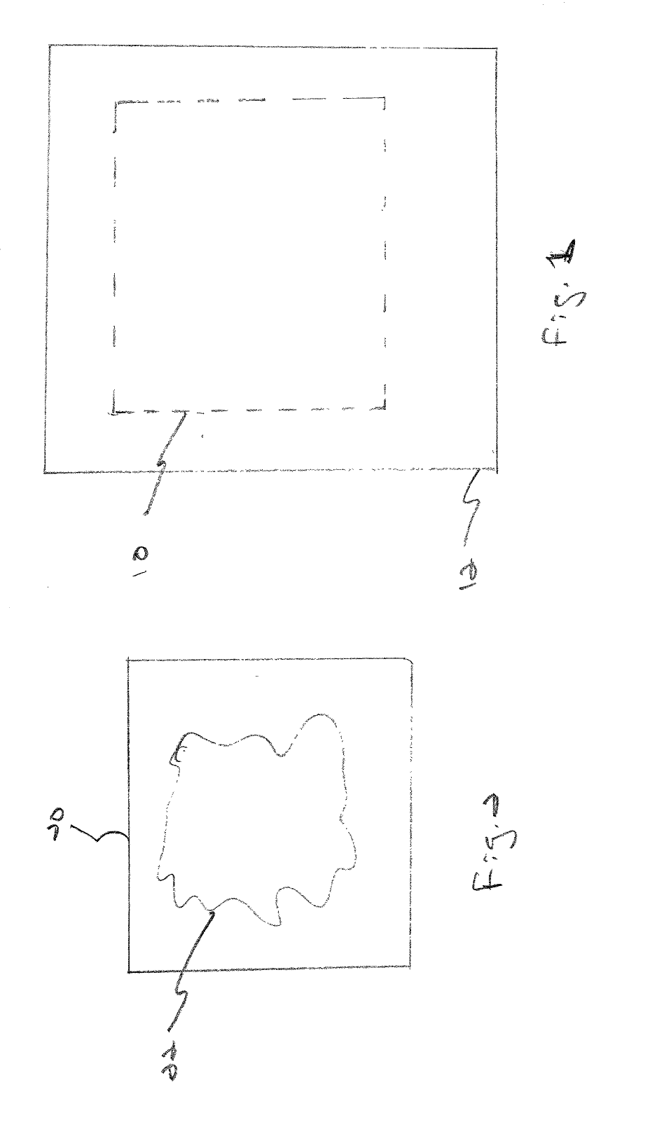

1. The preparation of the place or receiving area 10, FIG. 1, on a receiving object 12 where the ornamental pattern or motive is to be included;

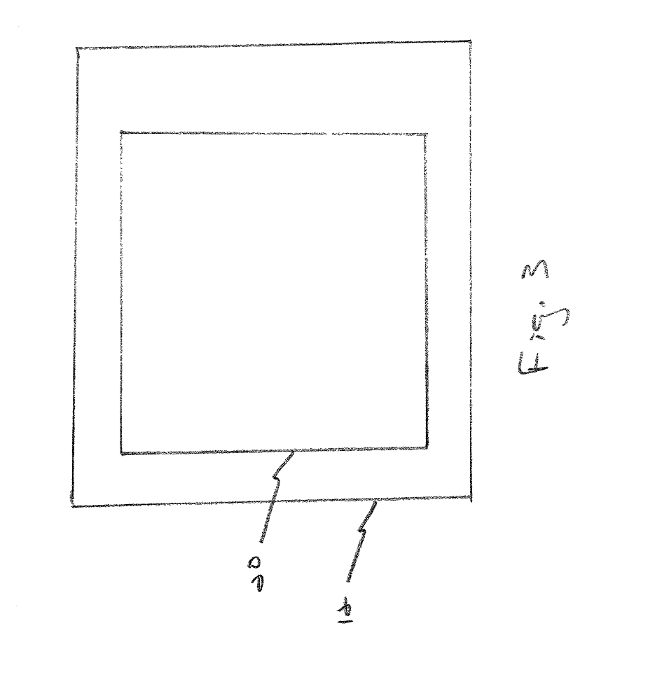

2. The creation of a transfer template or base 20, FIG. 2, with the desired pattern or motive 22 previously applied; and

3. The use of special paints or inks which can be subject to sublimation but maintain all their ranges and colors for the adornment of the motive incorporated in the template.

Later, the template 20, FIG. 3, is situated on the object 12 receiving the ornamental motive, and is submitted to an elevation of temperature, by, for example without limitation, placing the object and template on a heating plate so that the ornamental motive remains on the receiving element at the end of the sublimation process.

It is also a feature of the invention that the transmission of the pattern to the transfer template may be accomplished when the transfer template is manufactured solely and exclusively in paper, by means of using offset printing with special inks, which are well known in the art, for sublimation of patterns on paper.

### PREFERRED EMBODIMENT OF THE INVENTION

The procedure for the adornment by sublimation of objects 12 manufactured in a variety of materials is configured as from the determination of the place or region 10 where the ornamental pattern or motive is going to be included. This could be any apt material such as wood, chipboard, steel plates, aluminum, any type of metal, including the noble ones, plastic and its derivatives, petroleum materials in general, including precious and semi-precious stones, as well as furs, leathers, textiles and similar ones.

The ornamental motive 22 is incorporated on a template or base 20 that could be paper, plastic or any other material, making the ornamental motive using paint with all its ranges and colors.

Once the stated basic elements have been prepared, the method now proceeds to the act of preparing the surface or region 10 where the stamping of the pattern by means of sublimation is going to be done, it having previously been submitted to a buffing, sanding or similar stage.

The method next follows by painting or printing the transfer templates. The transfer template is then placed over the object to receive the ornamentation and the method begins to effect the sublimation process. This is done by applying said bases or templates, in any of the previously indicated components, which act as receptors, onto the object 12 with the paint or ink in contact with the surface region 10 on the object 12 which is to receive the ornamentation, and then raising the temperature to between 140° C. to 300° C., and preferably approximately 280° C. This in accomplished by placing a heating plate or element on top of the template which has previously been placed on top of the object in the desired location or position. In this way the pattern and its colors are passed from the template to the object of any material whatsoever that acts as a receptor. Thus the process of adornment is concluded, having used a plate with heating elements that permits achieving the indicated temperature. It should also be noted that the invention can use paper solely and exclusively as a template or base and the transmission of the patterns on this material can be done in two ways. These are:

1. Offset printing with special inks for sublimation.

2. The printing can be done by means of plotters with special inks for sublimation of patterns, likewise on paper.

Consequently, these two ways of printing can be done solely and exclusively on a paper base.

Also, the transfer of the sublimation of patterns previously done on paper can be effected on the following surfaces. These are:

Buffed, sanded or polished surfaces.

1. Varnished, lacquered and pigmented surfaces.

2. Surfaces treated with all types of resins.

3. Surfaces that are not buffed or sanded.

4. Finished surfaces.

5. Surfaces configured as paper impregnated with polyester and acrylic resins.

The applied temperature, depending on the surface, ranges between 140° C. and 300° C.

The transmission time, also depending on the surface, ranges between 5 and 60 seconds.

Modifications and substitutions by one of ordinary skill in the art are considered to be within the scope of the present invention which is not to be limited except by the claims which follow.

What is claimed is:

1. A method for the adornment of a desired pattern, by sublimation, of objects, comprising the acts of:
providing a transfer template on which resides said desired pattern;
placing said transfer template on said object, at least one region of said object for receiving said desired pattern;
exposing said transfer template in contact with said object to a desired transfer temperature, causing said desired pattern to be transferred, by sublimation, to said object.

2. The method of claim 1 wherein said transfer template is formed of paper.

3. The system of claim 2 wherein said desired pattern is provided on said transfer template in the form of an ink of at least one color.

4. The method of claim 3 wherein said ink of at least one color is applied by means of an offset printing process.

5. The system of claim 1 wherein said desired transfer temperature is in the range of 140° C.-300° C.

6. The method of claim 1 wherein said at least one region of said object for receiving said pattern has been previously treated by means selected from the group consisting of buffing, sanding, and polishing.

7. The method of claim 2 wherein said desired pattern has been applied to said transfer template by means of a plotter printing with special inks of at last one color.

8. The system of claim 1 wherein said at least one region on said object has been treated according to one method selected from the group consisting of varnished, lacquered, and pigmented.

9. The method of claim 1 wherein said object is selected from the group consisting of wood, chipboard, steel, aluminum, metal, plastic, petroleum-based materials, precious stone, semi-precious stones, furs, leathers, and textiles.

10. The method of claim 2 wherein said paper could further include a coating selected from the group consisting of polyester and acrylic resins.

11. The method of claim 1 wherein said desired transfer temperature is approximately 280° C.

12. The method of claim of claim 1 wherein said transfer template and said object ate held in alignment at said desired transfer temperature for a period of between 5 and 60 seconds.
